(19) United States
(12) Patent Application Publication
(10) Pub. No.: US 2025/0014342 A1
(43) Pub. Date: Jan. 9, 2025

(54) SEARCH APPARATUS, SEARCH METHOD, AND NON-TRANSITORY STORAGE MEDIUM

(71) Applicant: NEC Corporation, Minato-ku, Tokyo (JP)

(72) Inventor: Noboru YOSHIDA, Tokyo (JP)

(73) Assignee: NEC Corporation, Minato-ku, Tokyo (JP)

(21) Appl. No.: 18/708,229

(22) PCT Filed: Nov. 17, 2021
(86) PCT No.: PCT/JP2021/042224

§ 371 Date: May 8, 2024

(51) Int. Cl. G06V 20/40; G06F 16/532; G06T 7/246; G06V 10/74; G06V 40/10

(52) U.S. Cl. CPC G06V 20/48; G06F 16/532; G06T 7/246; G06V 10/761; G06V 20/46; G06V 40/10; G06T 2207/10016; G06T 2207/20092; G06T 2207/30196

(57) ABSTRACT

A search apparatus (10) according to the present invention includes: a key frame extraction unit (11) that extracts a plurality of key frames from a query moving image; and a search unit (12) that searches for a moving image similar to the query moving image, based on a pose of a human body included in each of the plurality of key frames and a time interval between the plurality of key frames.

### TECHNICAL FIELD

The present invention relates to a search apparatus, a search method, and a program.

### BACKGROUND ART

Techniques relating to the present invention are disclosed in Patent Document 1 and Non-Patent Document 1. Patent Document 1 discloses a technique for computing a feature value of each of a plurality of key points of a human body included in an image, and based on the computed feature value, searching for a still image including a human body having a pose similar to a pose of a human body indicated by a query or searching for a moving image including a human body exhibiting a movement similar to a movement of a human body indicated by the query. Further, Non-Patent Document 1 discloses a technique relating to skeleton estimation of a person.

### RELATED DOCUMENT

### Patent Document

Patent Document 1: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291-7299

### DISCLOSURE OF THE INVENTION

### Technical Problem

An issue of the present invention is to improve search accuracy for a moving image including a human body exhibiting a movement similar to a movement of a human body indicated by a query.

### Solution to Problem

According to the present invention, provided is a search apparatus including:
a key frame extraction unit that extracts a plurality of key frames from a query moving image; and
a search unit that searches for a moving image similar to the query moving image, based on a pose of a human body included in each of the plurality of key frames and a time interval between the plurality of key frames.

According to the present invention, provided is a search method including,
by a computer executing:
   a key frame extraction step of extracting a plurality of key frames from a query moving image; and
   a search step of searching for a moving image similar to the query moving image, based on a pose of a human body included in each of the plurality of key frames and a time interval between the plurality of key frames.

According to the present invention, provided is a program causing a computer to function as:
a key frame extraction unit that extracts a plurality of key frames from a query moving image; and
a search unit that searches for a moving image similar to the query moving image, based on a pose of a human body included in each of the plurality of key frames and a time interval between the plurality of key frames.

### Advantageous Effects of Invention

According to the present invention, search accuracy for a moving image including a human body exhibiting a movement similar to a movement of a human body indicated by a query is improved.

### BRIEF DESCRIPTION OF THE DRAWINGS

The above-described object, other objects, features, and advantages will become more apparent from public example embodiments described below and the following accompanying drawings.

FIG. 1 It is a diagram illustrating processing of extracting a key frame according to the present example embodiment.

FIG. 2 It is a diagram illustrating one example of a hardware configuration of a search apparatus according to the present example embodiment.

FIG. 3 It is a diagram illustrating one example of a function block diagram of the search apparatus according to the present example embodiment.

FIG. 4 It is a diagram illustrating processing of extracting a key frame according to the present example embodiment.

FIG. 5 It is a diagram illustrating a relevance frame, a time interval between a plurality of key frames, and a time interval between a plurality of relevance frames.

FIG. 6 It is a flowchart illustrating one example of a flow of processing of the search apparatus according to the present example embodiment.

FIG. 7 It is a diagram illustrating one example of a function block diagram of the search apparatus according to the present example embodiment.

FIG. 8 It is a diagram illustrating one example of a skeleton structure of a human body model detected by the search apparatus according to the present example embodiment.

FIG. 9 It is a diagram illustrating one example of a skeleton structure of a human body model detected by the search apparatus according to the present example embodiment.

FIG. 10 It is a diagram illustrating one example of a skeleton structure of a human body model detected by the search apparatus according to the present example embodiment.

FIG. 11 It is a diagram illustrating one example of a skeleton structure of a human body model detected by the search apparatus according to the present example embodiment.

FIG. 12 It is a diagram illustrating one example of a feature value of a key point computed by the search apparatus according to the present example embodiment.

FIG. 13 It is a diagram illustrating one example of a feature value of a key point computed by the search apparatus according to the present example embodiment.

FIG. 14 It is a diagram illustrating one example of a feature value of a key point computed by the search apparatus according to the present example embodiment.

FIG. 15 It is a flowchart illustrating one example of a flow of processing of the search apparatus according to the present example embodiment.

FIG. 16 It is a flowchart illustrating one example of a flow of processing of the search apparatus according to the present example embodiment.

FIG. 17 It is a diagram illustrating one example of a method according to the present example embodiment of specifying, by a user, a weight of a degree of similarity of a pose of a human body and a weight of a degree of similarity between a time interval between key frames and a time interval between relevance frames.

FIG. 18 It is a diagram illustrating one example of a method according to the present example embodiment of specifying, by a user, a weight of a degree of similarity of a pose of a human body and a weight of a degree of similarity between a time interval between key frames and a time interval between relevance frames.

### DESCRIPTION OF EMBODIMENTS

Hereinafter, example embodiments according to the present invention are described by using the accompanying drawings. Note that in all drawings, a similar component is assigned with a similar reference sign, and description thereof is omitted as appropriate.

### First Example Embodiment

### Outline

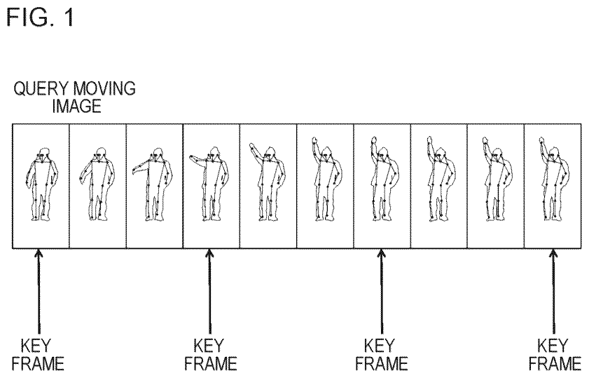

A search apparatus according to the present example embodiment, as illustrated in FIG. 1, extracts a plurality of key frames from a query moving image, and thereafter, searches for, based on a pose of a human body included in each of the plurality of key frames and a time interval between the plurality of key frames, a moving image including a human body exhibiting a movement similar to a movement of a human body (a temporal change of a pose of a human body) indicated by the query moving image.

In this manner, the search apparatus according to the present example embodiment is characterized by searching for a moving image, based on two elements including a pose of a human body included in each of a plurality of key frames and a time interval between the plurality of key frames.

### “Hardware Configuration”

Next, one example of a hardware configuration of the search apparatus is described. Each function unit of the search apparatus is achieved based on any combination of hardware and software mainly including a central processing unit (CPU) of any computer, a memory, a program loaded onto a memory, a storage unit (capable of storing, in addition to a program previously stored from a stage where an apparatus is shipped, a program downloaded from a storage medium such as a compact disc (CD), a server on the Internet, or the like) such as a hard disk storing the program, and an interface for network connection. Then, it should be understood by those of ordinary skill in the art that, in an achievement method and an apparatus for the above, there are various modified examples.

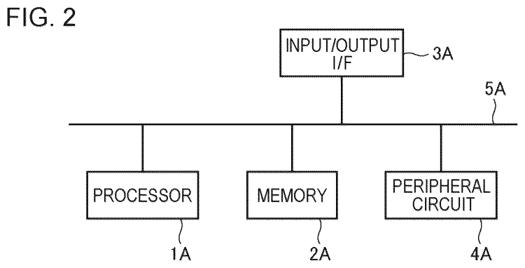

FIG. 2 is a block diagram illustrating the hardware configuration of the search apparatus. As illustrated in FIG. 2, the search apparatus includes a processor 1A, a memory 2A, an input/output interface 3A, a peripheral circuit 4A, and a bus 5A. The peripheral circuit 4A includes various modules. The search apparatus may not necessarily include the peripheral circuit 4A. Note that, the search apparatus may be configured by a plurality of apparatuses physically and/or logically separated. In this case, each of the plurality of apparatuses may include the above-described hardware configuration.

The bus 5A is a data transmission path through which the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, or the like. The output apparatus is, for example, a display, a speaker, a printer, a mailer, or the like. The processor 1A can issue instructions to each module, and perform an arithmetic operation, based on arithmetic operation results of the modules.

### “Function Configuration”

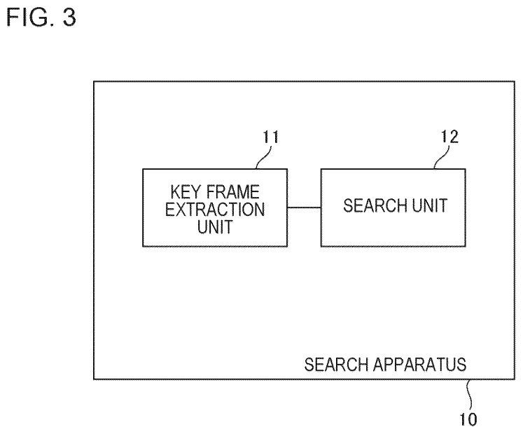

FIG. 3 illustrates one example of a function block diagram of a search apparatus 10 according to the present example embodiment. The illustrated search apparatus 10 includes a key frame extraction unit 11 and a search unit 12.

The key frame extraction unit 11 extracts a plurality of key frames from a query moving image.

The “query moving image” is a moving image to be a search query. The search apparatus 10 searches for a moving image including a human body exhibiting a movement similar to a movement of a human body indicated by a query moving image. One moving image file may be specified as a query moving image, or a scene of a part of one moving image file may be specified as a query moving image. For example, a user specifies a query moving image. Specification of a query moving image can be achieved by using any technique.

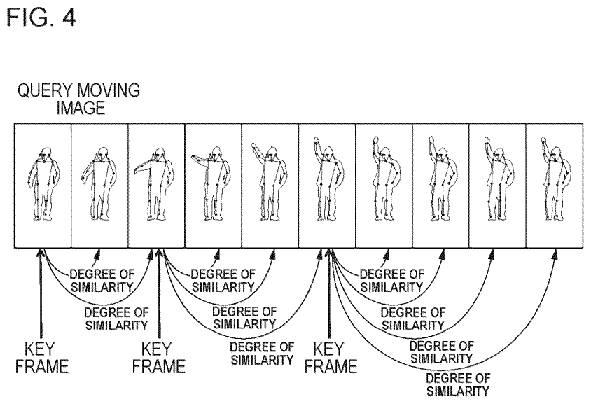

The “key frame” is a partial frame among a plurality of frames included in a query moving image. The key frame extraction unit 11 can intermittently extract, as illustrated in FIGS. 1 and 4, a key frame from among a plurality of time-series frames included in a query moving image. A time interval (the number of frames) between key frames may be fixed, or may be at random. The key frame extraction unit 11 can execute, for example, any of pieces of the following extraction processing 1 to 3.

### —Extraction Processing 1—

In extraction processing 1, the key frame extraction unit 11 extracts a key frame, based on a user input. In other words, a user performs input for specifying, as a key frame, a part of a plurality of frames included in a query moving image. Then, the key frame extraction unit 11 extracts, as a key frame, the frame specified by the user.

### —Extraction Processing 2—

In extraction processing 2, the key frame extraction unit 11 extracts a key frame in accordance with a previously-determined rule.

Specifically, the key frame extraction unit 11 extracts, as illustrated in FIG. 1, a plurality of key frames at a predetermined regular interval from among a plurality of frames included in a query moving image. In other words, the key frame extraction unit 11 extracts a key frame at an interval of M frames. The M is an integer, and is exemplified as, but not limited to, for example, equal to or more than 2 and equal to or less than 10. The M may be previously determined, or may be selected by a user.

### —Extraction Processing 3—

In extraction processing 3, the key frame extraction unit 11 extracts a key frame in accordance with a previously-determined rule.

Specifically, the key frame extraction unit 11 computes, as illustrated in FIG. 4, after extracting one key frame (e.g., a first frame), a degree of similarity between the key frame and each of frames in which a time-series order is posterior to the key frame. The degree of similarity is a degree of similarity of a pose of a human body included in each frame. A method of computing a degree of similarity of a pose is not specifically limited, and one example is described according to the following example embodiment. Then, the key frame extraction unit 11 extracts, as a new key frame, a frame in which a degree of similarity is equal to or less than a reference value (design matter) and a time-series order is earliest.

Next, the key frame extraction unit 11 computes a degree of similarity between a newly-extracted key frame and each of frames in which a time-series order is posterior to the key frame. Then, the key frame extraction unit 11 extracts, as a new key frame, a frame in which a degree of similarity is equal to or less than a reference value (design matter) and a time-series order is earliest. The key frame extraction unit 11 repeats the processing, and extracts a plurality of key frames. According to the processing, poses of human bodies included in neighboring key frames are different from each other to some extent. Therefore, while an increase of key frames is reduced, a plurality of key frames indicating a characteristic pose of a human body can be extracted. The reference value may be previously determined, may be selected by a user, or may be set by another means.

Referring back to FIG. 3, the search unit 12 searches for a moving image similar to a query moving image, based on a pose of a human body included in each of a plurality of key frames extracted by the key frame extraction unit 11 and a time interval between a plurality of key frames. A search for a moving image by the search unit 12 may be a search for a scene similar to a query moving image from one moving image file, may be a search for a moving image file including a scene similar to a query moving image from among a plurality of moving images, or may be another search.

The search unit 12 specifically searches for, as a moving image similar to a query moving image, a moving image satisfying the following conditions 1 and 2. Note that, the search unit 12 may search for a moving image further satisfying the following condition 3 in addition to the following conditions 1 and 2.

(Condition 1) A plurality of relevance frames relevant to a plurality of key frames each are included.

(Condition 2) A time interval between a plurality of relevance frames is similar to a time interval between a plurality of key frames at a predetermined level or more.

(Condition 3) An appearance order of a plurality of key frames in a query moving image and an appearance order of a plurality of relevance frames in a moving image are matched with each other.

Hereinafter each condition is described.
(Condition 1) A plurality of relevance frames relevant to a plurality of key frames each are included—

A relevance frame is a frame including a human body having a pose similar, at a predetermined level or more, to a pose of a human body included in a key frame. A method of computing a degree of similarity of a pose is not specifically limited, and one example is described according to the following example embodiment. When, from a query moving image, Q (Q is an integer equal to or more than 2) key frames are extracted, a moving image including Q relevance frames relevant to the Q key frames each satisfies the condition 1.

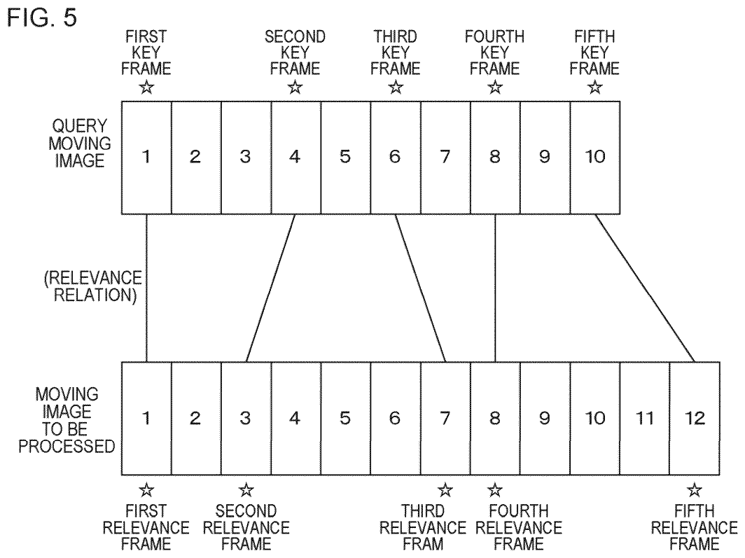

FIG. 5 illustrates a query moving image configured by ten frames. Then, in the figure, first, fourth, sixth, eighth, and tenth frames attached with a star mark are extracted as a key frame. Hereinafter, a key frame in which a time-series order among a plurality of key frames is referred to as an “Nth key frame”. The N is an integer equal to or more than 1. In an example in FIG. 5, the first frame is referred to as a first key frame, the fourth frame is referred to as a second key frame, the sixth frame is referred to as a third key frame, the eighth frame is referred to as a fourth key frame, and the tenth frame is referred to as a fifth key frame.

In the example in FIG. 5, a moving image including five relevance frames relevant to the first to fifth key frames each satisfies the condition 1. Incidentally, a moving image to be processed in FIG. 5 is a moving image satisfying the condition 1. The moving image to be processed is configured by 12 frames. In the figure, first, third, seventh, eighth, and twelfth frames are determined as a relevance frame. Hereinafter, a relevance frame relevant to the Nth key frame is referred to as an “Nth relevance frame”. In the moving image to be processed, the first frame is a first relevance frame, the third frame is a second relevance frame, the seventh frame is a third relevance frame, the eighth frame is a fourth relevance frame, and the twelfth frame is a fifth relevance frame.
(Condition 2) A time interval between a plurality of relevance frames is similar to a time interval between a plurality of key frames at a predetermined level or more—

First, by using FIG. 5, concepts of a “time interval between a plurality of relevance frames” and a “time interval between a plurality of key frames” are described.

In a case of the illustrated example, a time interval between a plurality of relevance frames is a time interval between the first to fifth relevance frames.

The time interval between a plurality of relevance images may be, for example, a concept including a time interval between temporally-neighboring relevance frames. In the case of the example in FIG. 5, the time interval between temporally-neighboring relevance frames includes a time interval between the first and second relevance frames, a time interval between the second and third relevance frames, a time interval between the third and fourth relevance frames, and a time interval between the fourth and fifth relevance frames.

In addition, the time interval between a plurality of relevance frames may be a concept including a time interval between temporally-first and temporally-last reference frames. In the case of the example in FIG. 5, the time interval between temporally-first and temporally-last reference frames is a time interval between the first and fifth relevance frames.

In addition, the time interval between a plurality of relevance frames may be a concept including a time interval between a relevance frame of a reference determined based on any method and each of other relevance frames. In the case of the example in FIG. 5, when, for example, the first relevance frame is employed as a reference relevance frame, a time interval between the reference relevance frame and each of other relevance frames includes a time interval between the first and second relevance frames, a time interval between the first and third relevance frames, a time interval between the first and fourth relevance frames, and a time interval between the first and fifth relevance frames. Note that, the reference relevance frame may be one, or may be plural.

The “time interval between a plurality of relevance frames” may be any one of a plurality of types of time intervals described above, or may include a plurality of types of time intervals. It is previously defined which of a plurality of types of time intervals described above is employed as a time interval between a plurality of relevance frames. In the case of the example in FIG. 5, any one or a plurality of time intervals among: a time interval between the first and second relevance frames, a time interval between the second and third relevance frames, a time interval between the third and fourth relevance frames, and a time interval between the fourth and fifth relevance frames (each of these is a time interval between temporally-neighboring relevance frames): a time interval between the first and fifth relevance frames (this is a time interval between temporally-first and temporally-last reference frames); and a time interval between the first and second relevance frames, a time interval between the first and third relevance frames, a time interval between the first and fourth relevance frames, and a time interval between the first and fifth relevance frames (each of these is one example of a time interval between a reference relevance frame and each of other relevance frames) are employed as a time interval between a plurality of relevance frames.

A concept of a time interval between a plurality of key frames is similar to the concept of the time interval between a plurality of relevance frames described above.

Note that, a time interval between two frames may be indicated based on the number of frames between the two frames, or may be indicated based on an elapsed time between two frames computed based on the number of frames between the two frames and a frame rate.

Next, a concept in that “a time interval between a plurality of relevance frames is similar to a time interval between a plurality of key frames at a predetermined level or more” is described. Herein, cases where a time interval between a plurality of relevance frames and a time interval between a plurality of key frames include one of the plurality of types of time intervals described above and include a plurality of the plurality of types of time intervals described above are described separately.

(A case where a time interval between a plurality of relevance frames and a time interval between a plurality of key frames include one type of a time interval)

In this case, a state where a difference between one type of a time interval between a plurality of relevance frames and one type of a time interval between a plurality of key frames is equal to or less than a threshold value is defined as a state where a time interval between a plurality of relevance frames is similar to a time interval between a plurality of key frames at a predetermined level or more. The threshold value is a design matter, and is previously set. The “difference between time intervals” is a margin or a change rate.

As one example, an example as follows is conceivable: a state where a difference between a time interval between temporally-first and temporally-last relevance frames and a time interval between temporally-first and temporally-last relevance frames is equal to or less than a threshold value is defined as a state where a time interval between a plurality of relevance frames is similar to a time interval between a plurality of key frames at a predetermined level or more. Note that, herein, the “time interval between a plurality of relevance frames” has been defined as a “time interval between temporally-first and temporally-last relevance frames”, and the “time interval between a plurality of key frames” has been defined as a “time interval between temporally-first and temporally-last key frames”, but these definitions are merely one example without limitation.

(A case where a time interval between a plurality of relevance frames and a time interval between a plurality of key frames include a plurality of types of time intervals)

In this case, it is determined that, for each of a plurality of types of time intervals, a difference between a time interval between relevance frames and a time interval between a plurality of key frames is equal to or less than a threshold value. The threshold value is a design matter, and is previously set for each of types of time intervals. Then, a state where the difference is equal to or less than the threshold value in a predetermined ratio or more of a plurality of types of time intervals is defined as a state where a time interval between a plurality of relevance frames is similar to a time interval between a plurality of key frames at a predetermined level or more.
(Condition 3) An appearance order of a plurality of key frames in a query moving image and an appearance order of a plurality of relevance frames in a moving image are matched with each other—

The condition 3 is that an application order of first to Qth key frames extracted from a query moving image and an application order in a moving image of first to Qth relevance frames relevant to each key frames are matched with each other. A moving image in which the first to Qth relevance frames appear in this order satisfies the condition, and a moving image in which the first to Qth relevance frames does not appear in this order does not satisfy the condition.

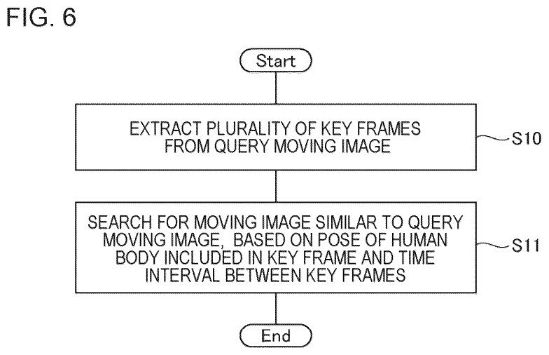

Next, by using a flowchart in FIG. 6, one example of a flow of processing based on the search apparatus 10 is described.

First, the processing apparatus 10 extracts, from a query moving image, a plurality of key frames (S10). Then, the processing apparatus 10 searches for a moving image similar to the query moving image, based on a pose of a human body included in each of the plurality of extracted key frames and a time interval between the plurality of extracted key frames (S11).

### Advantageous Effect

The search apparatus 10 according to the present example embodiment, as illustrated in FIG. 1, extracts a plurality of key frames from a query moving image, and thereafter, searches for, based on a pose of a human body included in each of the plurality of key frames and a time interval between the plurality of key frames, a moving image including a human body exhibiting a movement similar to a movement of a human body (a temporal change of a pose of a human body) indicated by the query moving image.

Specifically, the search apparatus 10 searches for a moving image in which a plurality of relevance frames relevant to a plurality of key frames each are included and a time interval between the plurality of relevance frames is similar to a time interval between the plurality of key frames. The relevance frame is a frame including a human body having a pose similar to a pose of a human body included in the key frame.

According to the search apparatus 10 described in this manner, a moving image in which a human body having a pose similar to each of a plurality of poses of a human body indicated by a query moving image is included and a speed (an interval between key frames) of a change of the pose is similar is searched for. For example, as illustrated in FIG. 1, when a human body exhibiting a movement for raising a right hand is indicated in a query moving image, a moving image in which a human body exhibiting a movement for raising the right hand is included and a speed of the movement for raising the right hand is similar to a speed indicated by the query moving image is searched for.

According to the search apparatus 10 according to the present example embodiment described in this manner, search accuracy for a moving image including a human body exhibiting a movement similar to a movement of a human body indicated by a query moving image is improved.

### Second Example Embodiment

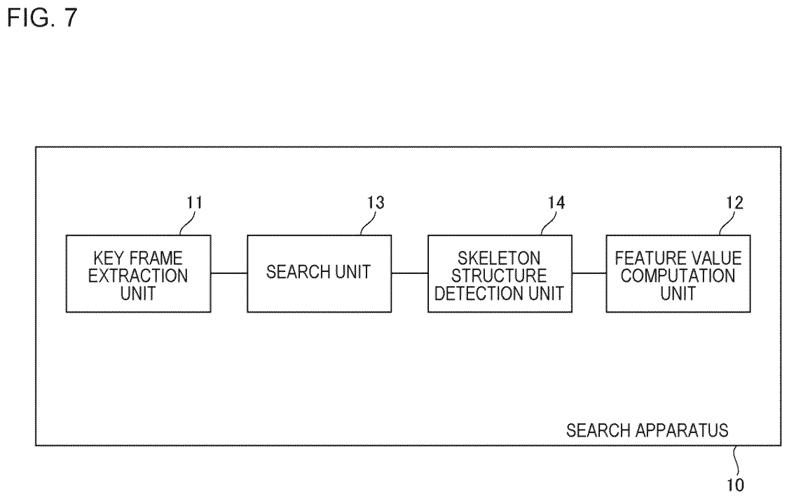

In a search apparatus 10 according to the present example embodiment, a method of computing a degree of similarity of a pose of a human body is embodied. FIG. 7 illustrates one example of a function block diagram of the search apparatus 10 according to the present example embodiment. As illustrated, the search apparatus 10 includes a key frame extraction unit 11, a skeleton structure detection unit 13, a feature value computation unit 14, and a search unit 12.

The skeleton structure detection unit 13 executes processing of detecting N (N is an integer equal to or more than 2) key points of a human body included in a key frame. The processing based on the skeleton structure detection unit 13 is achieved by using the technique disclosed in Patent Document 1. While description of details is omitted, in the technique disclosed in Patent Document 1, by using a skeleton estimation technique such as OpenPose disclosed in Non-Patent Document 1, a skeleton structure is detected. A skeleton structure detected based on the technique includes a “key point” being a characteristic point such as a joint and a “bone (bone link)” indicating a link between key points.

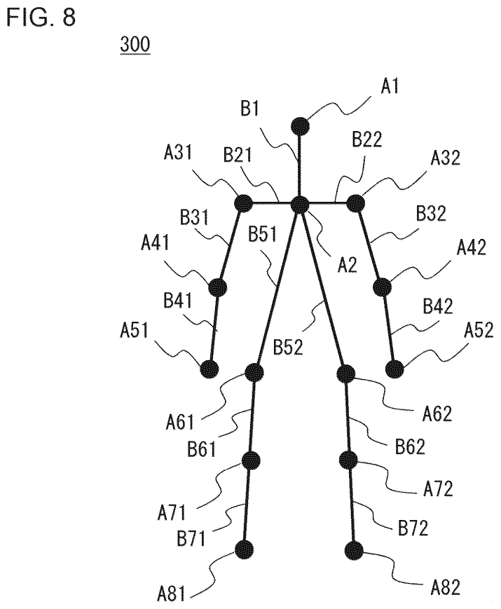

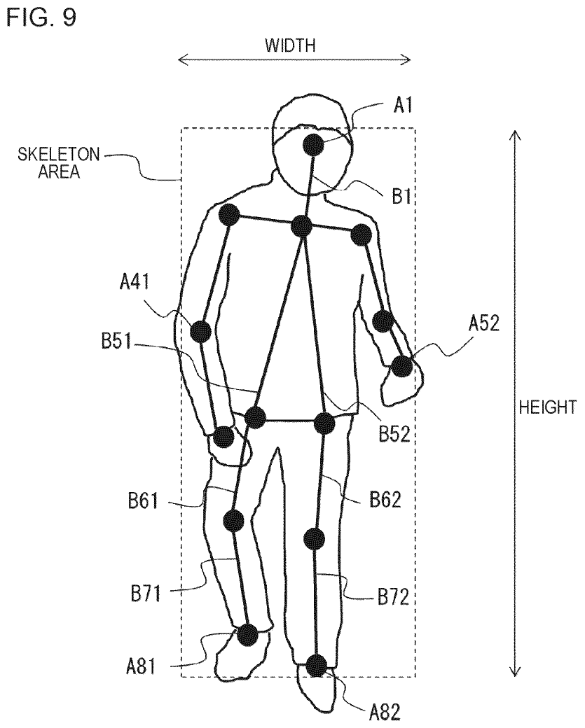

FIG. 8 illustrates a skeleton structure of a human body model 300 detected by the skeleton structure detection unit 13, and FIGS. 9 to 11 each illustrate a detection example of a skeleton structure. The skeleton structure detection unit 13 detects, by using a skeleton estimation technique such as OpenPose, a skeleton structure of the human body model (two-dimensional skeleton model) 300 as in FIG. 8 from a two-dimensional image. The human body model 300 is a two-dimensional model including a key point such as a joint of a person and a bone connecting each key point.

The skeleton structure detection unit 101, for example, extracts a keypoint recognizable as a key point from an image, refers to information acquired via machine learning of an image of the key point, and detects N key points of a human body. The N key points to be detected are previously determined. There are various points of view for the number (i.e., the number of N) of key points to be detected and what portion of a human body is designated as a key point to be detected, and any variation is employable.

In the example in FIG. 8, as a key point of a person, a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 are detected. Further, as a bone of a person connecting these key points, a bone B1 connecting the head A1 and the neck A2: a bone B21 and a bone 22 each connecting the neck A2, and the right shoulder A31 and the left shoulder A32: a bone 31 and a bone 32 each connecting the right shoulder A31 and the right elbow A41, and the left shoulder A32 and the left elbow A42: a bone B41 and a bone B42 each connecting the right elbow A41 and the right hand A51, and the left elbow A42 and the left hand A52; a bone B51 and a bone B52 each connecting the neck A2, and the right waist A61 and the left waist A62: a bone B61 and a bone B62 each connecting the right waist A61 and the right knee A71, and the left waist A62 and the left knee A72; and a bone B71 and a bone B72 each connecting the right knee A71 and the right foot A81, and the left knee A72 and the left foot A82 are detected.

FIG. 9 is an example in which a person in a standing-up state is detected. In FIG. 9, an image of a person standing-up is captured from a front side, the bone B1, the bone B51 and the bone B52, the bone B61 and the bone B62, and the bone B71 and the bone B72 each viewed from the front side are detected without overlapping with each other, and the bone B61 and the bone B71 of the right foot bend slightly more than the bone B62 and the bone B72 of the left foot.

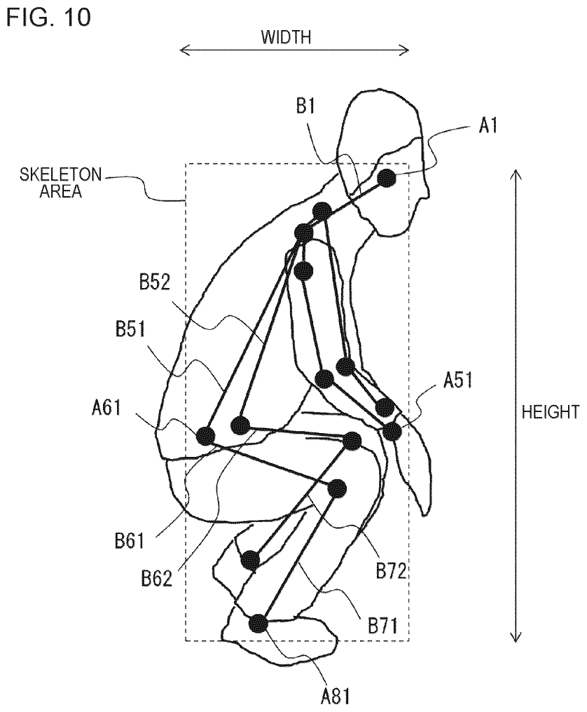

FIG. 10 is an example in which a person in a squatting-down state is detected. In FIG. 10, an image of a person squatting-down is captured from a right side, the bone B1, the bone B51 and the bone B52, the bone B61 and the bone B62, and the bone B71 and the bone B72 each viewed from the right side are detected, and the bone B61 and the bone B71 of the right foot and the bone B62 and the bone B72 of the left foot bend to a large extent and overlap with each other.

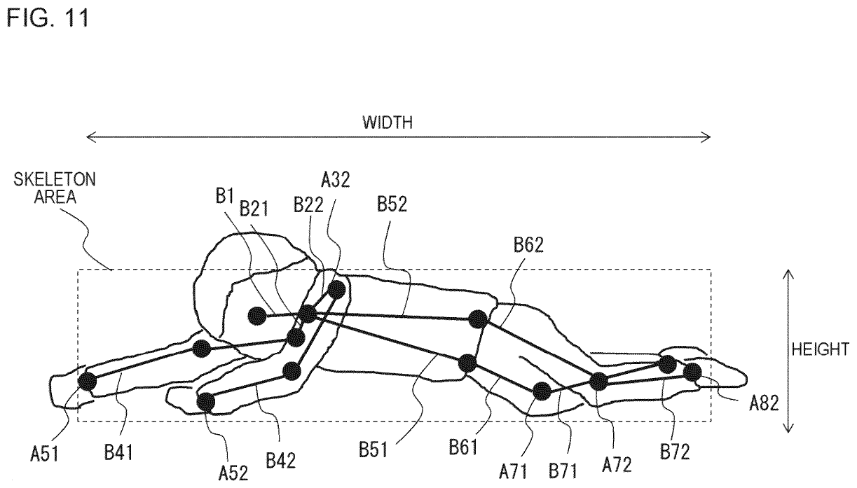

FIG. 11 is an example in which a person in a sleeping state is detected. In FIG. 11, an image of a sleeping person is captured from an obliquely left front side, the bone B1, the bone B51 and the bone B52, the bone B61 and the bone B62, and the bone B71 and the bone B72 each viewed from the obliquely left front side are detected, and the bone 61 and the bone B71 of the right foot and the bone B62 and the bone B72 of the left foot bend and overlap with each other.

Referring back to FIG. 7, the feature value computation unit 14 computes a feature value of a detected two-dimensional skeleton structure. The feature value computation unit 14 computes, for example, a feature value of each of detected key points.

A feature value of a skeleton structure indicates a feature of a skeleton of a person, and is an element for searching for, based on a skeleton of a person, a state (a pose or movement) of the person. Commonly, the feature value includes a plurality of parameters. Then, the feature value may be a feature value of an entire skeleton structure, may be a feature value of a part of a skeleton structure, or may include a plurality of feature values as seen in a portion of a skeleton structure. A computation method for a feature value may be any method such as machine learning and normalization, and as normalization, a minimum value and a maximum value may be determined. As one example, the feature value is a feature value acquired via machine learning of a skeleton structure, a size on an image from a head portion to a foot portion of a skeleton structure, a relative location relation among a plurality of key points in an upper and lower direction of a skeleton area including a skeleton structure on an image, a relative location relation among a plurality of key points in a left and right direction of the skeleton structure, or the like. The size of a skeleton structure is a height of an upper and lower direction, an area, or the like of a skeleton area including a skeleton structure on an image. The upper and lower direction (a height direction or a longitudinal direction) is an upper and lower direction (Y-axis direction) in an image, and is, for example, a direction perpendicular to a ground surface (reference surface). Further, the left and right direction (transverse direction) is a left and right direction (X-axis direction) in an image, and is, for example, a direction parallel to a ground surface.

Note that, in order to perform search desired by a user, a feature value having robustness against search processing is preferably used. When, for example, a user desires search independent of an orientation or a body shape of a person, a feature value robust against an orientation or a body shape of a person is usable. Skeletons of persons facing various directions with the same pose and skeletons of persons having various body shapes with the same pose are learned, or features only in the upper and lower direction of skeletons are extracted, and thereby, a feature value independent of a direction or a body shape of a person can be acquired.

The processing based on the feature value computation unit 14 is achieved by using the technique disclosed in Patent Document 1.

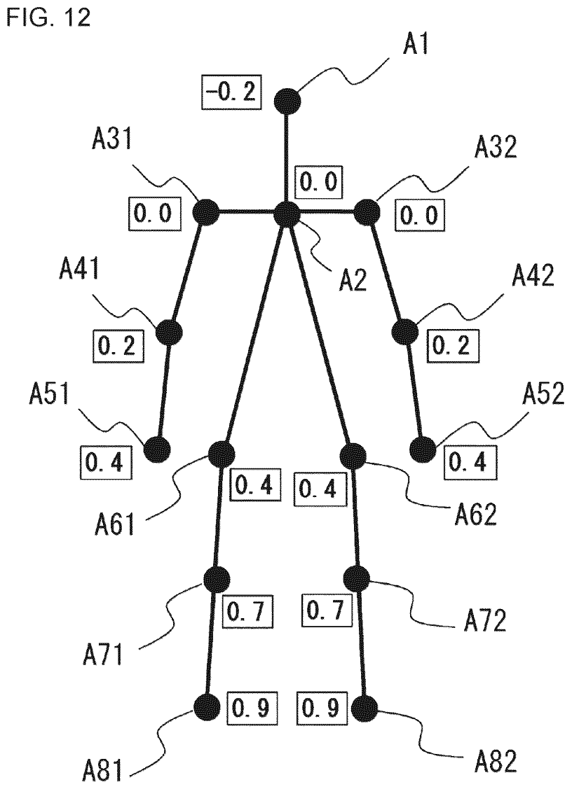

FIG. 12 illustrates an example of a feature value of each of a plurality of key points determined by the feature value computation unit 14. Note that, a feature value of a key point illustrated herein is merely one example without limitation.

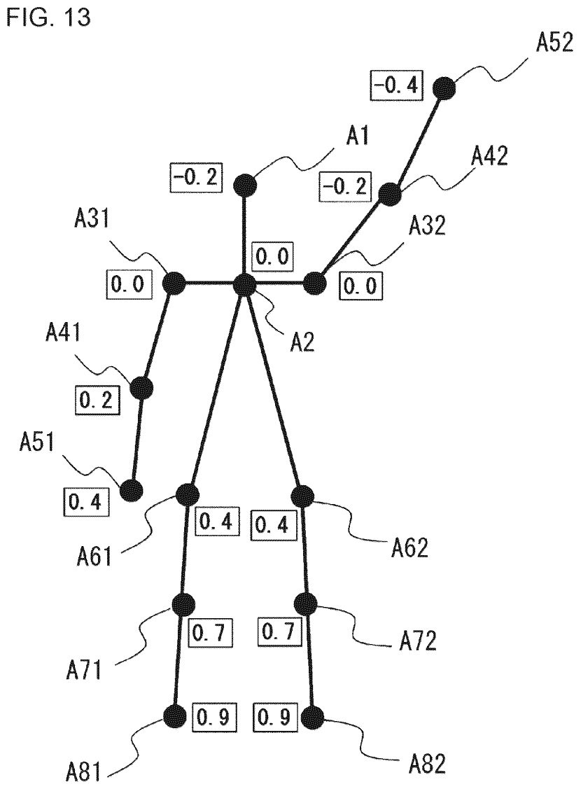

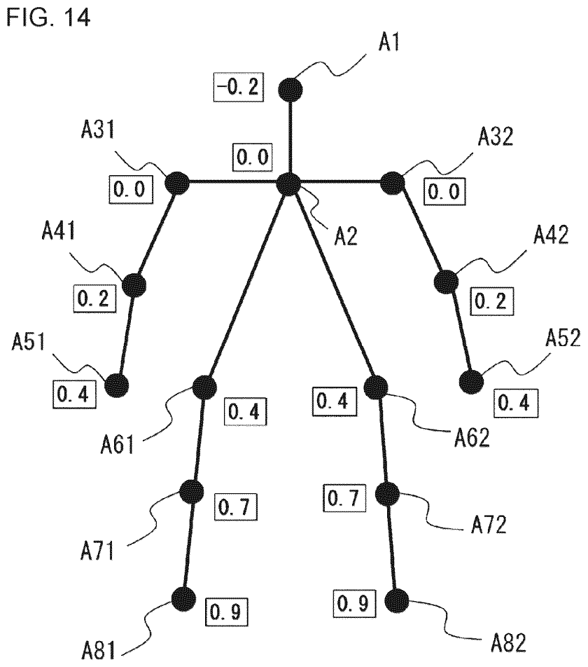

In this example, a feature value of a key point indicates a relative location relation among a plurality of key points in an upper and lower direction of a skeleton area including a skeleton structure on an image. The key point A2 of the neck is a reference point, and therefore, a feature value of the key point A2 is 0.0, and feature values of the key point A31 of the right shoulder and the key point A32 of the left shoulder having the same height as the neck each are also 0.0. A feature value of the key point A1 of the head higher than the neck is −0.2. Feature values of the key point A51 of the right hand and the key point A52 of the left hand each lower than the neck are 0.4, and feature values of the key point A81 of the right foot and the key point A82 of the left foot are 0.9. When a person raises the left hand from this state, the left hand becomes higher than the reference point as in FIG. 13, and therefore a feature value of the key point A52 of the left hand becomes −0.4. Meanwhile, normalization is performed by using only a coordinate of a Y-axis, and therefore, as in FIG. 14, compared with FIG. 7, even when a width of the skeleton structure changes, a feature value does not change. In other words, a feature value (normalized value) of the example indicates a feature in a height direction (Y direction) of a skeleton structure (key point), and a change of a horizontal direction (X direction) of the skeleton structure is subjected to no influence.

The search unit 12 computes, based on a feature value of a key point as described above, a degree of similarity of a pose of a human body, and searches for, based on a computation result, a moving image similar to a query moving image. As a method of the search, the technique disclosed in Patent Document 1 is employable.

Other configurations of the search apparatus 10 according to the present example embodiment are similar to those of the first example embodiment.

As described above, according to the search apparatus 10 of the present example embodiment, an advantageous effect similar to that of the first example embodiment is achieved. Further, according to the search apparatus 10 of the present example embodiment, based on a feature value of a two-dimensional skeleton structure of a human body, a pose of the human body can be determined. According to the search apparatus 10 of the present example embodiment described in this manner, a pose of a human body can be accurately determined. As a result, search accuracy for a moving image including a human body exhibiting a movement similar to a movement of a human body indicated by a query moving image is improved.

### Third Example Embodiment

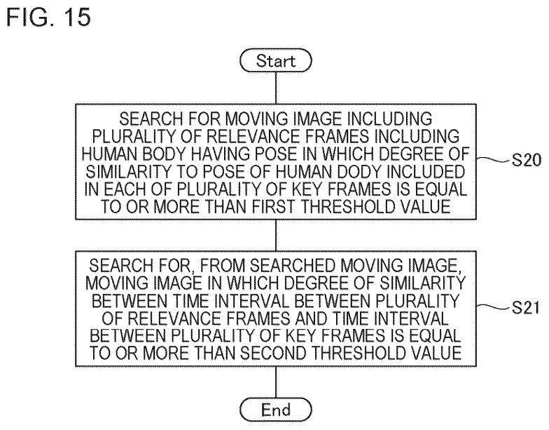

According to the present example embodiment, a flow of processing based on a search unit 12 is embodied. A flowchart in FIG. 15 illustrates one example of a flow of processing based on the search unit 12 according to the present example embodiment.

In S20, the search unit 12 searches for a moving image including Q relevance frames relevant to Q key frames each. An Nth relevance frame relevant to an Nth key frame includes a human body having a pose in which a degree of similarity to a pose of a human body included in the Nth key frame is equal to or more than a first threshold value.

In S21, the search unit 12 searches for, from the moving image searched in S20, a moving image in which a degree of similarity between a time interval between a plurality of relevance frames and a time interval between a plurality of key frames is equal to or more than a second threshold value. There are various computation methods for a degree of similarity between a time interval between a plurality of relevance frames and a time interval between a plurality of key frames.

When, for example, a time interval between a plurality of relevance frames and a time interval between a plurality of key frames include one type of a time interval, first, a difference between the time intervals is computed. The difference between time intervals is a margin or a change rate. The difference may be a degree of similarity. In addition, a value in which a computed difference is normalized in accordance with a predetermined rule may be a degree of similarity.

On the other hand, a time interval between a plurality of relevance frames and a time interval between a plurality of key frames include a plurality of types of time intervals, first, for each of types of time intervals, a difference between the time intervals is computed. The difference between time intervals is a margin or a change rate. Thereafter, a statistical value of differences among time intervals computed for each of types of time intervals is computed. As the statistical value, an average value, a maximum value, a minimum value, a mode, a median value, and the like are exemplified without limitation. The statistical value may be a degree of similarity. In addition, a value in which the computed statistical value is normalized in accordance with a predetermined rule may be a degree of similarity.

Concepts of “a case where a time interval between a plurality of relevance frames and a time interval between a plurality of key frames include one type of a time interval” and “a case where a time interval between a plurality of relevance frames and a time interval between a plurality of key frames include a plurality of types of time intervals” are as described according to the first example embodiment.

Note that, the first threshold value referred to in S20 and the second threshold value referred to in S21 may be previously set. Then, the search unit 12 may execute the search processing, based on the previously-set first threshold value and second threshold value.

In addition, a user may be able to specify at least one of the first threshold value and the second threshold value. Then, the search unit 12 may determine, based on a user input, at least one of the first threshold value and the second threshold value, and execute the search processing, based on the determined first threshold value and second threshold value.

When a time interval between a plurality of relevance frames and a time interval between a plurality of key frames include a plurality of types of time intervals as described according to the first example embodiment, the second threshold value is set for each of types of time intervals.

Other configurations of the search apparatus 10 according to the present example embodiment are similar to those of the first and second example embodiments.

According to the search apparatus 10 of the present example embodiment, an advantageous effect similar to that of the first and second example embodiments is achieved. Further, according to the search apparatus 10 of the present example embodiment, determination whether a movement (a change of a pose) is similar and determination whether a speed of a movement (a speed of a change of a pose) is similar are executed by being separately divided into a plurality of stages, and a reference (a first threshold value and a second threshold value) for determining similarity can be set for each stage. As a result, based on a desired reference, a search for a similar moving image can be executed.

### Fourth Example Embodiment

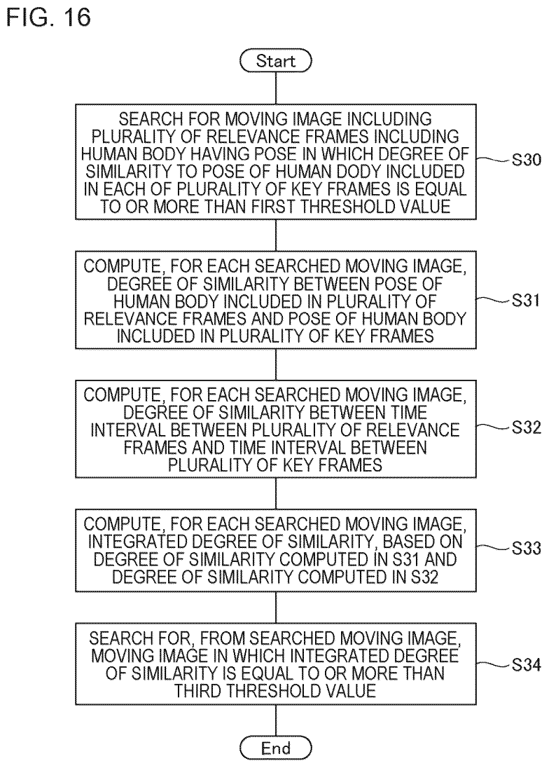

According to the present example embodiment, a flow of processing based on a search unit 12 is embodied. A flow of processing based on the search unit 12 according to the present example embodiment is different from the description according to the third example embodiment. A flowchart in FIG. 16 illustrates one example of the flow of processing of the search unit 12 according to the present example embodiment.

In S30, the search unit 12 searches for a moving image including Q relevance frames relevant to Q key frames each. An Nth relevance frame relevant to an Nth key frame includes a human body having a pose in which a degree of similarity to a pose of a human body included in the Nth key frame is equal to or more than a first threshold value.

In S31, the search unit 12 computes, for each moving image searched in S30, a degree of similarity (hereinafter, referred to as a “degree of similarity of a pose”) between a pose of a human body included in a plurality of relevance frames and a pose of a human body included in a plurality of key frames. There are various computation methods for a degree of similarity of a pose. For example, for each pair of a relevance frame and a key frame relevant to each other, a degree of similarity of a pose of a human body included in the each pair is computed. As a computation method for the degree of similarity, the method disclosed in Patent Document 1 is employable. Next, a statistical value of a plurality of degrees of similarity computed for each pair is computed. As the statistical value, an average value, a maximum value, a minimum value, a mode, a median value, and the like are exemplified without limitation. Thereafter, a value in which the computed statistical value is normalized in accordance with a predetermined rule is computed as a degree of similarity of a pose. Note that, the computation method for a degree of similarity of a pose exemplified herein is merely one example without limitation.

In S32, the search unit 12 computes, for each moving image searched in S30, a degree of similarity (hereinafter, referred to as a “degree of similarity of a time interval”) between a time interval between a plurality of relevance frames and a time interval between a plurality of key frames. There are various computation methods for a degree of similarity of a time interval.

When, for example, a time interval between a plurality of relevance frames and a time interval between a plurality of key frames include one type of a time interval, first, a difference between the time intervals is computed. The difference between time intervals is defined as a margin or a change rate. Thereafter, a value in which the computed difference is normalized in accordance with a predetermined rule may be computed as a degree of similarity.

On the other hand, when a time interval between a plurality of relevance frames and a time interval between a plurality of key frames include a plurality of types of time intervals, first, for each of types of time intervals, a difference between the time intervals is computed. The difference between time intervals is defined as a margin or a change rate. Thereafter, a statistical value of differences between time intervals computed for each of types of time intervals is computed. As the statistical value, an average value, a maximum value, a minimum value, a mode, a median value, and the like are exemplified without limitation. Thereafter, a value in which the computed statistical value is normalized in accordance with a predetermined rule is computed as a degree of similarity of a time interval.

Concepts of “a case where a time interval between a plurality of relevance frames and a time interval between a plurality of key frames include one type of a time interval” and “a case where a time interval between a plurality of relevance frames and a time interval between a plurality of key frames include a plurality of types of time intervals” are as described according to the first example embodiment.

In S33, the search unit 12 computes, for each moving image searched in S30, an integrated degree of similarity, based on the degree of similarity of a pose computed in S31 and the degree of similarity of a time interval computed in S32.

The search unit 12 may compute, as an integrated degree of similarity, for example, a sum or a product of a degree of similarity of a pose and a degree of similarity of a time interval.

In addition, the search unit 12 may compute, as an integrated degree of similarity, a statistical value of a degree of similarity of a pose and a degree of similarity of a time interval. As the statistical value, an average value, a maximum value, a minimum value, a mode, a median value, and the like are exemplified without limitation.

In addition, the search unit 12 may compute, as an integrated degree of similarity, a weighted average or a weighted sum of a degree of similarity of a pose and a degree of similarity of a time interval.

In S34, the search unit 12 searches for, from a moving image searched in S30, a moving image in which the integrated degree of similarity computed in S33 is equal to or more than a third threshold value.

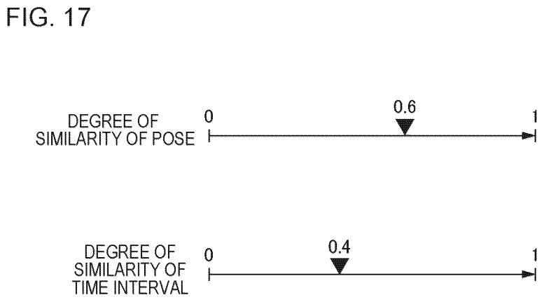

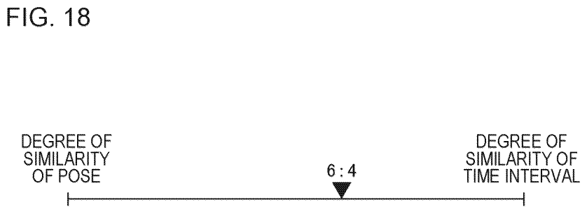

Note that, when, in S33, a weighted average or a weighted sum of a degree of similarity of a pose and a degree of similarity of a time interval is computed as an integrated degree of similarity, a weight of each of the degree of similarity of a pose and the degree of similarity of a time interval may be previously set, or may be specified by a user. In a case of specification based on a user, a specification based on a user may be received, for example, via a slider (a user interface (UI) component) as illustrated in FIGS. 17 and 18. The slider illustrated in FIG. 17 is configured in such a way as to specify a weight for each of a degree of similarity of a pose and a degree of similarity of a time interval. The slider illustrated in FIG. 18 is configured in such a way as to specify a ratio of a degree of importance between a degree of similarity of a pose and a degree of similarity of a time interval. Then, based on a specified degree of importance, each weight is computed. Note that, user input reception based on the slider is merely one example, and a user input may be received based on another method.

Further, the first threshold value referred to in S30 and the third threshold value referred to in S34 may be previously set. Then, the search unit 12 may execute the search processing, based on the previously-set first threshold value and third threshold value.

In addition, a user may be able to specify at least one of the first threshold value and the third threshold value. Then, the search unit 12 may determine, based on a user input, at least one of the first threshold value and the third threshold value, and execute the search processing, based on the determined first threshold value and third threshold value.

Other configurations of the search apparatus 10 according to the present example embodiment are similar to those of the first to third example embodiments.

According to the search apparatus 10 of the present example embodiment, an advantageous effect similar to that of the first to third example embodiments is achieved. Further, according to the search apparatus 10 of the present example embodiment, it is possible to search for a moving image in which an integrated degree of similarity acquired by integrating a degree of similarity of a movement (a degree of similarity of a pose) and a degree of similarity of a speed of a movement (a degree of similarity of a time interval) satisfies a reference. According to the search apparatus 10 of the present example embodiment described in this manner, a weight of a degree of similarity of a pose and a degree of similarity of a time interval is adjusted, and thereby, a search for a similar moving image can be executed based on a desired reference.

### Fifth Example Embodiment

A search apparatus 10 according to the present example embodiment includes first and second search modes. Then, the search apparatus 10 searches for, based on a search mode specified by a user, a moving image similar to a query moving image. The first search mode is a mode in which search is performed based on the method described according to the third example embodiment. The second mode is a mode in which search is performed based on the method described according to the fourth example embodiment.

Other configurations of the search apparatus 10 according to the present example embodiment are similar to those of the first to fourth example embodiments.

According to the search apparatus 10 of the present example embodiment, an advantageous effect similar to that of the first to fourth example embodiments is achieved. Further, according to the search apparatus 10 of the present example embodiment, a plurality of search modes are provided, and thereby, search can be performed based on a mode specified by a user. According to the search apparatus 10 of the present example embodiment, a selection width of a user is expanded, which is preferable.

### Sixth Example Embodiment

According to the present example embodiment, a user specifies, as a search condition, a lower limit of a moving image length of a moving image to be searched. Then, a search apparatus 10 searches for, as a moving image similar to a query moving image, a moving image in which a condition provided according to the first to fifth example embodiments is satisfied and a moving image length is equal to or more than a specified lower limit. In this case, a moving image in which a moving image length is less than a lower limit specified by a user is not searched. Thereby, while a human body exhibiting a movement similar to a movement of a human body indicated by a query moving image is included, a moving image in which a speed of the movement is higher than a predetermined level (a moving image in which a moving image length is shorter than a predetermined level) is not searched. Hereinafter, details are described.

A search unit 12 receives, as a search condition, a user input for specifying a lower limit of a moving image length. The search unit 12 may receive a user input for specifying a lower limit of a moving image length, by setting a length of a query moving image as a reference. The lower limit of a moving image may be specified, for example, as in “X times a length of a query moving image”. In this case, the search unit 12 receives a user input for specifying X. The X is a numerical value more than 0 and equal to or less than 1.

In addition, the search unit 12 may receive a user input for directly specifying, based on a numerical value or the like, a lower limit of a moving image length.

Next, a method of searching for a moving image in which a moving image length satisfies the search condition is described.

### Method 1

First, the search unit 12 determines, based on a lower limit of a moving image length specified by a user, a lower limit of the number of key frames to be extracted from a query moving image. The search unit 12 determines a lower limit of the number of key frames to be extracted from the query moving image in such a way that a length of a moving image including the extracted key frames is the lower limit of a moving image length specified by a user.

When, for example, a moving image length of a query moving image is “P frames” and a lower limit of a moving image length specified by a user is “0.5 times the moving image length of the query moving image”, the search unit 12 determines 0.5×P as a lower limit of the number of key frames to be extracted from the query moving image.

When a moving image length of a query moving image is “R seconds” and a lower limit of a moving image length specified by a user is “0.5 times the moving image length of the query moving image”, the search unit 12 determines 0.5×R×F₁ as a lower limit of the number of key frames to be extracted from the query moving image. The F₁ is a frame rate.

Then, a key frame extraction unit 11 extracts, from the query moving image, key frames having a number equal to or more than the lower limit of the number of key frames determined by the search unit 12.

When, for example, a key frame is extracted based on the extraction processing 1 described according to the first example embodiment, i.e., when a frame specified by a user is extracted as a key frame, a matter in that “a key frame having a number equal to or more than a lower limit of the number of key frames determined by the search unit 12 is specified” may be set as a condition for completing specification processing of a user. In other words, a user can finish processing of specifying a key frame when specifying a key frame having a number equal to or more than a lower limit of the number of key frames determined by the search unit 12.

In addition, when a key frame is extracted based on the extraction processing 2 described according to the first example embodiment, i.e., when a key frame is extracted every M frames, the key frame extraction unit 11 adjusts a value of M, and thereby, can adjust the number of key frames to be extracted. The key frame extraction unit 11 determines a value of M in such a way that the number of key frames to be extracted is equal to or more than a lower limit of the number of key frames determined by the search unit 12.

In addition, when a key frame is extracted based on the extraction processing 3 described according to the first example embodiment, i.e., when, as illustrated in FIG. 4, a frame in which a degree of similarity of a pose to a reference key frame is equal to or less than a reference value and a time-series order is earliest is sequentially extracted as a new key frame, the key frame extraction unit 11 adjusts a reference value of the degree of similarity, and thereby, can adjust the number of key frames to be extracted. The key frame extraction unit 11 determines a reference value of the degree of similarity in such a way that the number of key frames to be extracted is equal to or more than a lower limit of the number of key frames determined by the search unit 12.

Incidentally, the search unit 12 searches for a moving image including a plurality of relevance frames relevant to a plurality of extracted key frames each. When a lower limit of the number of key frames to be extracted from a query moving image is determined in such a way that a length of a moving image including extracted key frames is a lower limit of a moving image length specified by a user, necessarily, a moving image shorter than the lower limit of a moving image length specified by the user is not searched.

### Method 2

First, the search unit 12 determines, based on a user input, a lower limit of a moving image length. When the lower limit of a moving image length is specified as in “X times a length of a query moving image”, the search unit 12 determines, as the lower limit of a moving image, a product of a length of a query moving image and X specified by a user. In addition, when the lower limit of a moving image length is directly specified based on a numerical value or the like, the search unit 12 determines, as the lower limit of a moving image length, a numerical value specified by a user.

Then, the search unit 12 searches for a moving image in which an elapsed time between a temporally-first relevance frame and a temporally-last relevance frame is equal to or more than a lower limit of a determined moving image length as a moving image satisfying a search condition for a lower limit of the moving image.

Other configurations of the search apparatus 10 according to the present example embodiment are similar to those of the first to fifth example embodiments.

According to the search apparatus 10 of the present example embodiment, an advantageous effect similar to that of the first to fifth example embodiments is achieved. Further, according to the search apparatus 10 of the present example embodiment, a user can specify a moving image length, i.e., a lower limit of a time during which a movement indicated by a query moving image is exhibited. According to the search apparatus 100 described in this manner, a moving image in which, while a human body exhibiting a movement similar to a movement of a human body indicated by a query moving image is included, a speed of the movement is higher than a predetermined level (a moving image in which a moving image length is shorter than a predetermined level) is not searched. As a result, a search desired by a user is made possible.

While with reference to the accompanying drawings, the example embodiments according to the present invention have been described, the example embodiments are exemplification of the present invention and various configurations other than the above-described configurations are employable. Configurations according to the above-described example embodiments may be combined with each other or a part of the configurations may be replaced with another configuration. Further, configurations according to the above-described example embodiments may be subjected to various changes without departing from the spirit of the present invention. Further, configurations and processing disclosed according to each above-described example embodiment and modified example may be combined with each other.

Further, in a plurality of flowcharts used in the above-described description, a plurality of steps (pieces of processing) are described in order, but an execution order of steps to be executed according to each example embodiment is not limited to the described order. According to each example embodiment, an order of illustrated steps can be modified within an extent that there is no harm in context. Further, the above-described example embodiments can be combined within an extent that there is no conflict in content.

The whole or part of the example embodiments described above can be described as, but not limited to, the following supplementary notes.

1. A search apparatus including:
a key frame extraction unit that extracts a plurality of key frames from a query moving image; and
a search unit that searches for a moving image similar to the query moving image, based on a pose of a human body included in each of the plurality of key frames and a time interval between the plurality of key frames.

2. The search apparatus according to supplementary note 1, wherein
the search unit
   includes a plurality of relevance frames including a human body having a pose in which a degree of similarity to a pose of a human body included in each of the plurality of key frames is equal to or more than a first threshold value, and
   includes a first search mode that searches for, as a moving image similar to the query moving image, a moving image in which a degree of similarity between a time interval between the plurality of key frames and a time interval between the plurality of relevance frames is equal to or more than a second threshold value.

3. The search apparatus according to supplementary note 2, wherein
the search unit determines, based on a user input, at least one of the first threshold value and the second threshold value.

4. The search apparatus according to any one of supplementary notes 1 to 3, wherein
the search unit,
for each moving image to be processed,
   determines a plurality of relevance frames relevant to each of the plurality of key frames,
   computes an integrated degree of similarity, based on a degree of similarity between a pose of a human body included in each of the plurality of key frames and a pose of a human body included in each of the plurality of relevance frames, and a degree of similarity between a time interval between the key frames and a time interval between the relevance frames, and
   includes a second search mode that searches for, as a moving image similar to the query moving image, the moving image to be processed in which the integrated degree of similarity is equal to or more than a third threshold value.

5. The search apparatus according to supplementary note 4, wherein
a time interval between the key frames includes at least one of a time interval between two temporally-neighboring key frames, and a time interval between temporally-first and temporally-last key frames.

6. The search apparatus according to supplementary note 4 or 5, wherein
the search unit
   computes the integrated degree of similarity, based on a weight of a degree of similarity of a pose of a human body specified by a user and a weight of a degree of similarity between a time interval between the key frames and a time interval between the relevance frames.

7. The search apparatus according to any one of supplementary notes 1 to 6, wherein
the key frame extraction unit
   extracts the key frame having a value equal to or more than a lower limit of the key frame to be extracted determined based on a lower limit of a moving image length specified as a search condition by a user.

8. The search apparatus according to supplementary note 7, wherein
the key frame extraction unit
   determines a number of key frames to be extracted in such a way that a length of a moving image including a plurality of the extracted key frames is equal to or more than a lower limit of a moving image length specified by a user.

9. A search method including,
by a computer executing:
   a key frame extraction step of extracting a plurality of key frames from a query moving image; and
   a search step of searching for a moving image similar to the query moving image, based on a pose of a human body included in each of the plurality of key frames and a time interval between the plurality of key frames.

10. A program causing a computer to function as:
a key frame extraction unit that extracts a plurality of key frames from a query moving image; and
a search unit that searches for a moving image similar to the query moving image, based on a pose of a human body included in each of the plurality of key frames and a time interval between the plurality of key frames.

### REFERENCE SIGNS LIST

10 Search apparatus
11 Key frame extraction unit
12 Search unit
13 Skeleton structure detection unit
14 Feature value computation unit
1A Processor
2A Memory
3A Input/output I/F
4A Peripheral circuit
5A Bus

What is claimed is:

1. A search apparatus comprising:
at least one memory configured to store one or more instructions; and
at least one processor configured to execute the one or more instructions to:
extract a plurality of key frames from a query moving image; and
search for a moving image similar to the query moving image, based on a pose of a human body included in each of the plurality of key frames and a time interval between the plurality of key frames.

2. The search apparatus according to claim 1, wherein
the at least one processor is further configured to execute the one or more instructions to
include a plurality of relevance frames including a human body having a pose in which a degree of similarity to a pose of a human body included in each of the plurality of key frames is equal to or more than a first threshold value, and
include a first search mode that searches for, as a moving image similar to the query moving image, a moving image in which a degree of similarity between a time interval between the plurality of key frames and a time interval between the plurality of relevance frames is equal to or more than a second threshold value.

3. The search apparatus according to claim 2, wherein
the at least one processor is further configured to execute the one or more instructions to determine, based on a user input, at least one of the first threshold value and the second threshold value.

4. The search apparatus according to claim 1, wherein
the at least one processor is further configured to execute the one or more instructions to,
for each moving image to be processed,
determine a plurality of relevance frames relevant to each of the plurality of key frames,
compute an integrated degree of similarity, based on a degree of similarity between a pose of a human body included in each of the plurality of key frames and a pose of a human body included in each of the plurality of relevance frames, and a degree of similarity between a time interval between the key frames and a time interval between the relevance frames, and
include a second search mode that searches for, as a moving image similar to the query moving image, the moving image to be processed in which the integrated degree of similarity is equal to or more than a third threshold value.

5. The search apparatus according to claim 4, wherein
a time interval between the key frames includes at least one of a time interval between two temporally-neighboring key frames, and a time interval between temporally-first and temporally-last key frames.

6. The search apparatus according to claim 4 or 5, wherein
the at least one processor is further configured to execute the one or more instructions to
compute the integrated degree of similarity, based on a weight of a degree of similarity of a pose of a human body specified by a user and a weight of a degree of similarity between a time interval between the key frames and a time interval between the relevance frames.

7. The search apparatus according to claim 1, wherein
the at least one processor is further configured to execute the one or more instructions to
extract the key frame having a value equal to or more than a lower limit of the number of the key frame to be extracted determined based on a lower limit of a moving image length specified as a search condition by a user.

8. The search apparatus according to claim 7, wherein
the at least one processor is further configured to execute the one or more instructions to
determine a number of key frames to be extracted in such a way that a length of a moving image including a plurality of the extracted key frames is equal to or more than a lower limit of a moving image length specified by a user.

9. A search method comprising,
by a computer executing:
extracting a plurality of key frames from a query moving image; and
searching for a moving image similar to the query moving image, based on a pose of a human body included in each of the plurality of key frames and a time interval between the plurality of key frames.

10. A non-transitory storage medium storing a program causing a computer to:
extract a plurality of key frames from a query moving image; and
search for a moving image similar to the query moving image, based on a pose of a human body included in each of the plurality of key frames and a time interval between the plurality of key frames.

11. The search method according to claim 9, wherein
the computer
includes a plurality of relevance frames including a human body having a pose in which a degree of similarity to a pose of a human body included in each of the plurality of key frames is equal to or more than a first threshold value, and
includes a first search mode that searches for, as a moving image similar to the query moving image, a moving image in which a degree of similarity between a time interval between the plurality of key frames and a time interval between the plurality of relevance frames is equal to or more than a second threshold value.

12. The search method according to claim 11, wherein
the computer determines, based on a user input, at least one of the first threshold value and the second threshold value.

13. The search method according to claim 9, wherein
the computer,
for each moving image to be processed,
determines a plurality of relevance frames relevant to each of the plurality of key frames,
computes an integrated degree of similarity, based on a degree of similarity between a pose of a human body included in each of the plurality of key frames and a pose of a human body included in each of the plurality of relevance frames, and a degree of similarity between a time interval between the key frames and a time interval between the relevance frames, and
includes a second search mode that searches for, as a moving image similar to the query moving image, the moving image to be processed in which the integrated degree of similarity is equal to or more than a third threshold value.

14. The search method according to claim 13, wherein
a time interval between the key frames includes at least one of a time interval between two temporally-neighboring key frames, and a time interval between temporally-first and temporally-last key frames.

15. The search method according to claim 13, wherein
the computer
computes the integrated degree of similarity, based on a weight of a degree of similarity of a pose of a human body specified by a user and a weight of a degree of similarity between a time interval between the key frames and a time interval between the relevance frames.

16. The non-transitory storage medium according to claim 10, wherein
the program causing the computer to
include a plurality of relevance frames including a human body having a pose in which a degree of similarity to a pose of a human body included in each of the plurality of key frames is equal to or more than a first threshold value, and
include a first search mode that searches for, as a moving image similar to the query moving image, a moving image in which a degree of similarity between a time interval between the plurality of key frames and a time interval between the plurality of relevance frames is equal to or more than a second threshold value.

17. The non-transitory storage medium according to claim 16, wherein
the program causing the computer to determine, based on a user input, at least one of the first threshold value and the second threshold value.

18. The non-transitory storage medium according to claim 10, wherein
the program causing the computer to,
for each moving image to be processed,
determine a plurality of relevance frames relevant to each of the plurality of key frames,
compute an integrated degree of similarity, based on a degree of similarity between a pose of a human body included in each of the plurality of key frames and a pose of a human body included in each of the plurality of relevance frames, and a degree of similarity between a time interval between the key frames and a time interval between the relevance frames, and
include a second search mode that searches for, as a moving image similar to the query moving image, the moving image to be processed in which the integrated degree of similarity is equal to or more than a third threshold value.

19. The non-transitory storage medium according to claim 18, wherein
a time interval between the key frames includes at least one of a time interval between two temporally-neighboring key frames, and a time interval between temporally-first and temporally-last key frames.

20. The non-transitory storage medium according to claim 18, wherein
the program causing the computer to
compute the integrated degree of similarity, based on a weight of a degree of similarity of a pose of a human body specified by a user and a weight of a degree of similarity between a time interval between the key frames and a time interval between the relevance frames.
